(19) United States
(12) Patent Application Publication
(10) Pub. No.: US 2025/0209652 A1
(43) Pub. Date: Jun. 26, 2025

(54) METHOD AND SYSTEM FOR SIMULTANEOUS LOCALIZATION AND MAPPING BASED ON 2D LIDAR AND A CAMERA WITH DIFFERENT VIEWING RANGES

(71) Applicants: HYUNDAI MOTOR COMPANY, Seoul (KR); KIA CORPORATION, Seoul (KR)

(72) Inventors: Sanghyeon Oh, Seoul (KR); Dong Hwan Kwak, Hwaseong-si (KR); Hyuntek Lim, Hwaseong-si (KR)

(73) Assignees: HYUNDAI MOTOR COMPANY, Seoul (KR); KIA CORPORATION, Seoul (KR)

(21) Appl. No.: 18/744,304

(22) Filed: Jun. 14, 2024

(30) Foreign Application Priority Data
Dec. 26, 2023 (KR) 10-2023-0190894

(51) Int. Cl. G06T 7/579; G01S 17/89; G06T 5/70; G06V 10/44; G06V 10/75

(52) U.S. Cl. CPC G06T 7/579; G01S 17/89; G06T 5/70; G06V 10/44; G06V 10/751; G06T 2207/30252

(57) ABSTRACT

A system for simultaneous localization and mapping (SLAM) includes a Lidar sensor configured to detect a feature point in front of a vehicle and a camera configured to acquire a front image of the vehicle. The system also includes a controller configured to receive data on the feature point from the Lidar sensor and the front image from the camera, search for the feature point from the front image, set the feature point received from the Lidar sensor and the feature point searched from the front image as a point cloud (PCL), and perform SLAM based on the feature point in the PCL. The controller is further configured to remove a feature point satisfying a removal condition from the PCL in response to an arrival of an object search cycle, and add a newly searched feature point after a previous object search cycle to the PCL.

### CROSS-REFERENCE TO RELATED APPLICATION

This application claims priority to and the benefit of Korean Patent Application No. 10-2023-0190894 filed in the Korean Intellectual Property Office on Dec. 26, 2023, the entire contents of which are hereby incorporated herein by reference.

### BACKGROUND

### (a) Technical Field

The present disclosure relates to a simultaneous localization and mapping (SLAM) method and a SLAM system, and more particularly, to a method and a system for simultaneous localization and mapping that secures robustness by maintaining feature points detected by a camera with a relatively narrow viewing angle in accordance with a relatively wide viewing angle of a light detection and ranging (Lidar) sensor.

### (b) Description of the Related Art

Simultaneous localization and mapping (SLAM) refers to a technology in which a mobility vehicle detects the current location of the mobility vehicle and simultaneously creates a map of surrounding environment while navigating through an unknown environment. SLAM may be performed based on 2D Lidar or 3D Lidar. However, due to the high price and large computational amount of SLAM based on 3D Lidar, SLAM based on 3D Lidar has rarely been applied to small mobility vehicles, such as mobility vehicles that do not transport people. Accordingly, SLAM based on 2D Lidar has been mainly applied to small mobility objects.

When performing SLAM based on 2D Lidar, areas that are not at a height where a laser is irradiated may not be recognized, resulting in constructing an incorrect map. In order to solve the problems of SLAM performed based on the 2D Lidar, a method of performing SLAM by fusing data detected by the 2D Lidar and data detected using a camera is being studied.

However, a viewing angle of the camera is relatively narrow. Thus, feature points that are out of a field of view of the camera due to movement of the mobility vehicle may be detected by the 2D Lidar with a relatively wide viewing angle but may be recognized as non-existing feature points and may not be reflected in the SLAM. As a result, an incorrect map may be created and there is a risk that driving safety would be harmed.

The above information disclosed in this Background section is provided only to enhance of understanding of the background of the disclosure. Therefore, the Background section may contain information that does not form the prior art that is already known to a person of ordinary skill in the art.

### SUMMARY

Embodiments of the present disclosure provide a method and a system for simultaneous localization and mapping that secures robustness by maintaining feature points detected by a camera with a relatively narrow viewing angle in accordance with a relatively wide viewing angle of a Lidar sensor.

According to an embodiment, a system for simultaneous localization and mapping (SLAM). The system includes a light detection and ranging (Lidar) sensor configured to detect a feature point in front of a vehicle. The system also includes a camera configured to acquire a front image of the vehicle. The system additionally includes a controller configured to receive data on the feature point in front of the vehicle from the Lidar sensor. The controller is also configured to receive the front image of the vehicle from the camera. The controller is additionally configured to search for the feature point from the front image. The controller is further configured to set the feature point received from the Lidar sensor and the feature point searched from the front image as a point cloud (PCL) and perform SLAM based on the feature point in the PCL. The controller is further configured to remove a feature point satisfying a removal condition from the PCL in response to an arrival of an object search cycle. The controller is additionally configured to add a newly searched feature point after a previous object search cycle to the PCL. The feature point that satisfies the removal condition may be a feature point whose distance to the vehicle is greater than a first set distance.

The controller may be further configured to maintain, in the PCL, a feature point that does not satisfy the removal condition.

The controller may be configured to first remove the feature point that satisfies the removal condition from the PCL and then add the newly searched feature point to the PCL.

The controller may be further configured to set the newly searched feature point after the previous object search cycle as a new point cloud (nPCL). The controller may additionally be configured to determine whether the feature point in the nPCL is the same as the feature point in the PCL. The controller may further be configured to add the corresponding feature point in the nPCL to the PCL in response to determining that the feature point in the nPCL is not the same as the feature point in the PCL.

The controller may be configured to determine that the feature point in the nPCL is not the same as the feature point in the PCL in response to determining that a minimum value of a distance between the feature point in the nPCL and the feature point in the PCL is greater than or equal to a second set distance.

The controller may be configured to determine that a positional relationship between the feature point in the nPCL and the feature point other than the corresponding feature point in the PCL matches a positional relationship between the corresponding feature point in the PCL and the feature point other than the corresponding feature point in the PCL in response to determining that the minimum value of the distance between the feature point in the nPCL and the feature point in the PCL is less than the second set distance. The controller may also be configured to determine that the feature point in the nPCL is not the same as the feature point in the PCL in response to determining that the positional relationship between the feature point in the nPCL and the feature point other than the corresponding feature point in the PCL does not match the position relationship between the feature point in the PCL and the feature point other than the corresponding feature point in the PCL.

The controller may be further configured to determine that the corresponding feature point in the nPCL is the same as the corresponding feature point in the PCL in response to determining that the positional relationship between the feature point in the nPCL and the feature point other than the corresponding feature point in the PCL matches the positional relationship between the corresponding feature point in the PCL and the feature point other than the corresponding feature point in the PCL.

The controller may be further configured to remove noise in the nPCL through data clustering.

According to another embodiment, a method for simultaneous localization and mapping (SLAM) is provided. The method includes receiving, by a controller of a vehicle, data on a feature point in front of the vehicle from a light detection and ranging (Lidar) sensor in response to SLAM being triggered. The method also includes receiving, by the controller, a front image of the vehicle from a camera and searching for a feature point from the front image. The method additionally includes setting, by the controller, the feature point transmitted from the Lidar sensor and the feature point searched from the front image as a point cloud (PCL). The method further includes removing, by the controller, a feature point that satisfies a removal condition from the PCL in response to an arrival of an object search cycle. The method further includes adding, by the controller, a newly searched feature point after a previous object search cycle to the PCL.

The feature point that satisfies the removal condition may be the feature point where a distance to the vehicle is greater than a first set distance.

The method may further include maintaining, by the controller, in the PCL, the feature point that does not satisfy the removal condition.

Adding a newly searched feature point after a previous object search cycle to the PCL may include setting the newly searched feature point after the previous object search cycle as a new point cloud (nPCL). Adding the newly searched feature point may also include determining whether the feature point in nPCL is the same as the feature point in PCL. Adding the newly searched feature point may additionally include adding the corresponding feature point in the nPCL to the PCL in response to determining that the feature point in the nPCL is not the same as the feature point in the PCL.

Determining whether the feature point in the nPCL is the same as the feature point in the PCL may include comparing a minimum value of a distance between the feature point in the nPCL and the feature point in the PCL with a second set distance.

Determining whether the feature point in the nPCL is the same as the feature point in the PCL may include determining that the feature point in the nPCL is not the same as the feature point in the PCL in response to determining that the minimum value of the distance between the feature point in the nPCL and the feature point in the PCL is greater than or equal to the second set distance.

Determining whether the feature point in the nPCL is the same as the feature point in the PCL may further include determining whether a positional relationship between the feature point in the nPCL and the feature point other than the corresponding feature point in the PCL matches a positional relationship between the corresponding feature point in the PCL and the feature point other than the corresponding feature point in the PCL in response to determining that the minimum value of the distance between the feature point in the nPCL and the feature point in the PCL is less than the second set distance.

Determining whether the feature point in the nPCL is the same as the feature point in the PCL may further include determining that the feature point in the nPCL is not the same as the feature point in the PCL in response to determining that the positional relationship between the feature point in the nPCL and the feature point other than the corresponding feature point in the PCL does not match the positional relationship between the corresponding feature point in the PCL and the feature point other than the corresponding feature point in the PCL.

Determining whether the feature point in the nPCL is the same as the feature point in the PCL may further include determining that the corresponding feature point in the nPCL is the same as the corresponding feature point in the PCL in response to determining that the positional relationship between the feature point in the nPCL and the feature point other than the corresponding feature point in the PCL matches the positional relationship between the feature point in the PCL and the feature point other than the corresponding feature point in the PCL.

Adding a newly searched feature point to the PCL after a previous object search cycle may further include removing noise in the nPCL through data clustering.

According to embodiments of the present disclosure, when a feature point is within a viewing angle of a Lidar sensor even if the feature point is out of a field of view of a camera, the feature point that was detected by the camera is maintained as the feature point, thereby securing the robustness of SLAM.

By deleting the feature point only when a distance between the corresponding feature point and the vehicle is greater than a first preset distance, it is possible to reduce the memory usage while securing the robustness of SLAM.

By deleting the feature points corresponding to the deletion conditions and then adding new feature points, it is possible to further reduce the memory usage and computational amount.

Other effects that can be obtained or are expected from embodiments of the present disclosure are explicitly or implicitly set forth in the detailed description of the present disclosure. In other words, various effects obtained or expected according to the present disclosure are described directly or implicitly in the following detailed description.

### BRIEF DESCRIPTION OF THE DRAWINGS

Embodiments of the present disclosure should be more clearly understood by referring to the following description in conjunction with the accompanying drawings, where like reference numerals refer to identical or functionally similar elements.

FIG. 1 is a block diagram of a system for simultaneous localization and mapping, according to an embodiment of the present disclosure.

FIG. 2 is a flowchart of a method for simultaneous localization and mapping, according to another embodiment of the present disclosure.

FIG. 3 is a flowchart of an operation of removing feature points that satisfy a removal condition from a point cloud (PCL) in the method of FIG. 2, according to an embodiment.

FIG. 4 is a flowchart of an operation of adding a new point cloud in the method of FIG. 2, according to an embodiment.

FIG. 5 is a diagram illustrating feature points detected by a Lidar sensor and a camera, according to an embodiment.

FIG. 6 is a diagram illustrating removal of noise from the feature points detected as illustrated in FIG. 5, according to an embodiment.

FIG. 7 is a diagram illustrating deleting stored feature points, according to an embodiment.

FIG. 8 is a diagram illustrating maintaining stored feature points and adding new feature points, according to an embodiment.

FIG. 9 is a diagram illustrating a point cloud (PCL) in which the stored feature points are maintained and the new feature points are added as illustrated in FIG. 8, according to an embodiment.

FIG. 10A is a diagram illustrating an example of a map of an arbitrary location, according to an embodiment.

FIG. 10B is a diagram illustrating an example of a map created with a conventional 2D SLAM for the location illustrated in FIG. 10A.

FIG. 10C is a diagram illustrating an example of a map created using SLAM for the location illustrated in FIG. 10A, according to an embodiment of the present disclosure.

It should be understood that the drawings referenced above are not necessarily drawn to scale. The drawings present rather simplified representations of various features illustrating the basic principles of the present disclosure. For example, specific design features of the present disclosure, including specific dimensions, direction, position, and shape, will be determined in part by specific intended applications and use environments.

### DETAILED DESCRIPTION

The terminology used herein is for the purpose of describing particular embodiments. The terminology is not intended to limit the present disclosure. As used herein, singular forms are intended to also include plural forms unless the context clearly dictates otherwise. The terms “includes,” r “including,” “comprises,” “comprising,” or the like, specify the cited features, integers, steps, operations, elements, and/or the presence of components when used herein. However, it should be understood that these terms do not exclude the presence or addition of one or more of other features, integers, steps, operations, elements, components, and/or groups thereof. As used herein, the term “and/or” includes any one or all combinations of the associated listed items.

In various embodiments, “mobility vehicle,” “of a mobility vehicle,” “vehicle,” or other similar terms, as used herein are inclusive of motor vehicles in general. Such motor vehicles may include passenger vehicles, sport utility vehicles (SUVs), buses, trucks, various commercial vehicles, etc. Such motor vehicles may also include marine mobility vehicles such as various types of boats and ships. Such motor vehicles may also include aerial mobility vehicles such as aircraft, drones, etc., and include all objects that may move by receiving power from a power source. In addition, as used herein, “mobility vehicle,” “of a mobility vehicle,” “vehicle,” or other similar terms, include hybrid mobility vehicles, electric mobility vehicles, plug-in hybrid mobility vehicles, hydrogen-powered mobility vehicles, and other alternative fuel (e.g., fuels derived from resources other than oil) mobility vehicles. The hybrid mobility vehicles include mobility vehicles with two or more power sources such as gasoline power and electric power. Mobility vehicles according to embodiments of the present disclosure include mobility vehicles driven autonomously and/or automatically as well as mobility vehicles driven manually.

Additionally, it should be understood that one or more of methods according to embodiments of the present disclosure or aspects thereof may be executed by at least one or more controllers. The term “controller” may refer to a hardware device including a memory and a processor. The memory is configured to store program instructions, and the processor is specifically programmed to execute the program instructions to perform one or more processes described in more detail below. The controller may control operations of units, modules, parts, devices, or the like, as described herein. It should also be understood that methods according to embodiments of the present disclosure may be executed by an apparatus including a controller in conjunction with one or more other components, as should be appreciated by those having ordinary skill in the art.

In addition, the controller of the present disclosure may be implemented as a non-transitory computer-readable recording medium including executable program instructions executed by a processor. Examples of the computer-readable recording medium include read-only memory (ROM), random access memory (RAM), compact disk (CD) ROM, magnetic tapes, floppy disks, flash drives, smart cards, and/or optical data storage devices. However, the present disclosure is not limited thereto. The computer-readable recording medium may also be distributed throughout a computer network so that the program instructions may be stored and executed in a distributed manner, for example, on a telematics server or a controller Area Network (CAN).

When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings.

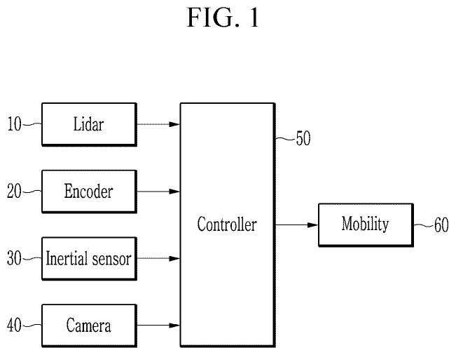

FIG. 1 is a block diagram of a system for simultaneous localization and mapping, according to an embodiment of the present disclosure.

As illustrated in FIG. 1, a system of simultaneous localization and mapping according to an embodiment of the present disclosure includes a light detection and ranging (Lidar) sensor (also sometimes referred to herein as simply “Lidar”) 10, an encoder 20, an inertial sensor 30, a camera 40, a controller 50, and a mobility vehicle 60 (which may be referred to herein simply as a “vehicle”).

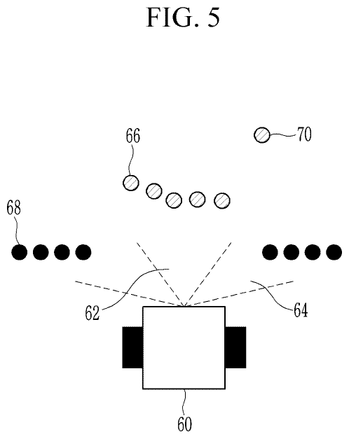

The Lidar 10 may be mounted on the vehicle 60. The Lidar 10 may emit a laser pulse in front of the vehicle 60 and may detect a return time of the laser pulse reflected from an object within a field of view 64 (as illustrated in FIG. 5, for example) of the Lidar 10 to thus detect information on the object, such as a distance from the Lidar 10 to the object and a direction, a speed, a temperature, a material distribution, concentration feature, or the like of the object. The object may be another vehicle, a person, a thing, or the like that exists outside the vehicle 60 equipped with the Lidar sensor 10. However, the present disclosure is not limited to any particular type of the object. The Lidar 10 may be connected to the controller 50 to detect object data (e.g., a plurality of feature points included in the object) within the field of view 64 of the Lidar 10 and to transmit the object data to the controller 50. As used herein, a set of the feature points is referred to as a point cloud (PCL).

The encoder 20 detects information on a rotation of a driving motor or a wheel provided in the vehicle 60. The encoder 20 may be connected to the controller 50 and may transmit the information on the detected rotation of the driving motor or the wheel to the controller 50. The controller 50 may calculate movement data of the vehicle 60, such as movement speed and/or movement distance of the vehicle 60, based on the information on the rotation of the driving motor or the wheel.

The inertial sensor 30 detects information on a movement status of the vehicle 60, including the speed, a direction, gravity, and/or acceleration of the vehicle 60. The inertial sensor 30 may be connected to the controller 50 and may transmit the information on the measured movement status of the vehicle 60 to the controller 50. The controller 50 may detect or supplement the movement data of the vehicle 60 based on the information on the movement status of the vehicle 60.

Here, it is illustrated and described that both the encoder 20 and the inertial sensor 30 are used as a movement data sensor that detects the movement data of the vehicle 60. However, in another embodiment, only one of the encoder 20 and the inertial sensor 30 may be used as the movement data sensor. In addition, the movement data sensor is not limited to the encoder 20 and the inertial sensor 30. Rather, the movement data sensor may additionally, or alternatively, include various other sensors that detect the movement data of the vehicle 60.

The camera 40 may be mounted on the vehicle 60. The camera 40 may acquire a front image of the vehicle 60 within a field of view 62 (as illustrated in FIG. 5, for example) of the camera 40. The camera 40 may be connected to the controller 50 and may transmit the acquired image to the controller 50.

The controller 50 may receive i) the object data from the Lidar 10, receives the information on the rotation of the driving motor or the wheel from the encoder 20, ii) the information on the movement status of the vehicle 60 from the inertial sensor 30, and iii) the front image of the vehicle 60 from the camera 40.

The controller 50 is configured to search for the objects (e.g., feature points) in the image through an object search algorithm such as an artificial neural network based on the received front image. As used herein, the set of feature points searched from the front image is also referred to as the point cloud (PCL).

The controller 50 is configured to remove the feature points that satisfy a removal condition from the point cloud (PCL) at every predetermined object search cycle. The controller 50 is also configured to update the point cloud (PCL) by adding the feature point newly searched by the camera 40 to the point cloud (PCL).

The controller 50 detects the movement data of the vehicle 60 based on the information on the rotation of the driving motor or the wheel received from the encoder 20 or the information on the movement situation of the vehicle 60 received from the inertial sensor 30. The controller 50 estimates a location of the vehicle 60 based on the movement data of the vehicle 60 and detects the absolute location of the vehicle 60 through a known localization method. The controller 50 is configured to perform SLAM based on an absolute location of the vehicle 60 and the updated PCL.

The controller 50 may be equipped with one or more microprocessors. The one or more microprocessors may be programmed to perform the steps or operations to perform SLAM according to embodiments of the present disclosure.

The controller 50 is connected to the vehicle 60. The controller 50 may create a path for the vehicle 60 or control the movement of the vehicle 60 using a map produced using SLAM according to embodiments of the present disclosure. For example, the controller 50 may control the vehicle 60 to follow the object or control the vehicle 60 to avoid the object.

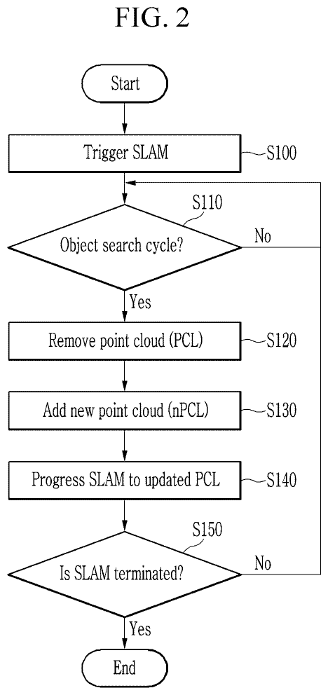

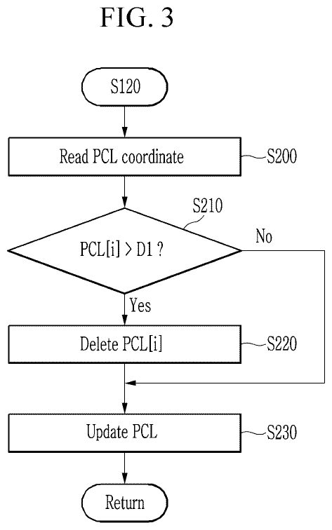

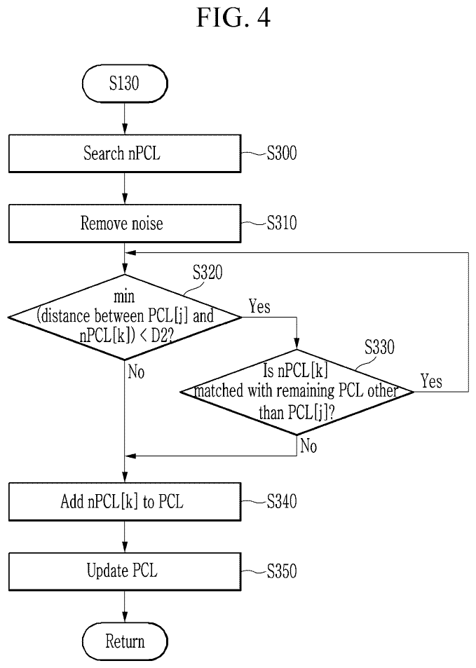

FIG. 2 is a flowchart of a method of simultaneous location and mapping, according to an embodiment of the present disclosure. FIG. 3 is a flowchart of removing feature points that satisfy a removal condition from a point cloud (PCL) in a step or operation S120 of FIG. 2, according to an embodiment. FIG. 4 is a flowchart of adding a new point cloud (nPCL) to the point cloud (PCL) in a step or operation step S130 of FIG. 2, according to an embodiment.

As illustrated in FIG. 2, a method for simultaneous localization and mapping according to an embodiment of the present disclosure begins when the vehicle 60 is turned on. For example, a user may press a start button of the vehicle 60 or may turn the vehicle 60 on through a user interface.

In a step or operation S100, when the vehicle 60 is turned on, the user may press a SLAM button provided on the vehicle 60 or may trigger the SLAM through the user interface. When SLAM is triggered, the Lidar 10 detects feature points in front of the vehicle 60 and the camera 40 detects the front image of the vehicle 60. The controller 50 receives data on the feature points in front of the vehicle 60 from the Lidar 10, receives the front image of the vehicle 60 from the camera 40 to search for the feature points from the front image, and sets the feature points transmitted from the Lidar 10 and the feature points searched from the front image as the point cloud (PCL). The controller 50 may remove noise from the PCL through data clustering, etc.

In a step or operation S110, the controller 50 determines whether a preset object search cycle has arrived. The object search cycle may be 30 frames per second (FPS). However, the present disclosure is not limited thereto.

When the controller 50 determines that the object search cycle has not arrived in the step or operation S110, the controller 50 waits until the object search cycle arrives. On the other hand, when the controller 50 determines that the object search cycle has arrived in the step or operation S110, the controller 50 removes the feature points that satisfy a removal condition from the point cloud (PCL) in a step or operation S120. As described above, PCL refers to the set of the feature points detected by the Lidar 10 and the camera 40. As also described above, the PCL may be updated in a previous object search cycle and stored in a memory, etc., of the controller 50. In addition, the removal condition may be that a distance between any feature point in the PCL and the vehicle 60 is greater than a first set distance D1. In an embodiment, when the removal condition is satisfied, the corresponding feature point is removed from the PCL. By removing the feature points first when updating the PCL, it is possible to reduce memory usage and reduce a computational amount required to perform the method according to embodiments of the present disclosure. The step or operation S120, according to an embodiment, is described in more detail below with reference to FIG. 3.

As illustrated in FIG. 3, in a step or operation S200, the controller 50 reads coordinates of the feature point included in the PCL stored in the memory. For example, when the PCL includes n feature points, the coordinates of each feature point are read from PCL[1] to PCL[n]. Typically, the coordinates of the feature points, that may include both absolute coordinates and relative coordinates with respect to the vehicle 60, are stored in the memory. However, when only the absolute coordinates of the feature points are stored in the memory, the controller 50 may detect the relative coordinates of the feature points in the step or operation S200.

When the coordinates of the feature points are read from the memory in the step or operation S200, the controller 50 determines whether the distance between any feature point included in the PCL and the vehicle 60 is greater than the first set distance D1 in a step or operation S210. Since the relative coordinates of the feature point with respect to the vehicle 60 are read in the step or operation S200, the controller 50 calculates the distance between any feature point and the vehicle 60 using the relative coordinates and determines whether the calculated distance is greater than the first set distance D1. The first set distance D1 may be a distance that has little influence on the path of the vehicle 60. The first set distance D1 may be appropriately set by a person having ordinary skill in the art.

When it is determined in the or operation step S210 that the distance between any feature point and the vehicle 60 is less than or equal to the first set distance D1, the method proceeds to a step or operation S230. In the step or operation S230, the controller 50 updates the PCL. On the other hand, when it is determined in the step or operation S210 that the distance between any feature point and the vehicle 60 is greater than the first set distance D1, the controller 50 deletes the corresponding feature point (e.g., PCL[i]) in a step or operation step S220 and then updates the PCL in the step or operation S230.

The steps or operations S210-S230 are repeated for all the feature points in the PCL. In other words, when n feature points are included in the PCL, the steps or operations S210-S230 are repeated n times.

Referring back to FIG. 2, when the feature point that satisfies the removal condition is removed from the PCL in the or operation step S120, the controller 50 adds a new point cloud (nPCL) to the point cloud (PCL) in a step or operation S130. The step or operation S130, according to an embodiment, is described in more detail with reference to FIG. 4.

As illustrated in FIG. 4, the controller 50 searches for new feature points in a step or operation S300. Here, a set of new feature points is referred to as the new point cloud (nPCL).

When the new feature points are searched, the controller 50 removes noise from the nPCL in a step or operation S310. For example, outliers in the nPCL are removed through data clustering. Since data clustering is well known to those having ordinary skilled in the art, a detailed description thereof has been omitted.

Thereafter, the controller 50 determines whether the feature point in the nPCL is the same as the feature point in the PCL. Various methods may be used to determine whether the feature point in the nPCL is the same as the feature point in the PCL. A method using a distance between any feature point in the nPCL and any feature point in the PCL is described below as an example.

First, the controller 50 calculates a distance between any feature point (nPCL[k]) in the nPCL and any feature point (PCL[j]) in the PCL, and determines whether a minimum value (min (distances between PCL[j] and nPCL[k])) of the distances between any feature point in the nPCL and the feature points in the PCL is less than a second set distance D2 in a step or operation S320. The second set distance D2 may be a distance at which nPCL[k] may be viewed as the same feature point as PCL[j]. The second set distance D2 may be set appropriately by a person having ordinary skill in the art.

When it is determined that the minimum value of the distances between any feature point (nPCL[k]) in the nPCL and the feature points in the PCL is greater than or equal to the second set distance D2, the controller 50 adds the corresponding feature point (nPCL[k]) in the nPCL to the PCL in a step or operation S340.

When it is determined that the minimum value of the distances between any feature point (nPCL[k]) in the nPCL and the feature points in the PCL is less than the second set distance D2, the controller 50 determines whether any feature point (nPCL[k]) in the nPCL matches the remaining feature points in the PCL other than the corresponding feature point (PCL[j]) in the PCL with the minimum distance therebetween in a step or operation S330. Even if the distance between any feature point (nPCL[k]) in the nPCL and the feature point (PCL[j]) in the PCL is small, any feature point (nPCL[k]) in the nPCL may be a feature point that is not searched in the previous object search cycle. The controller 50 determines whether any feature point (nPCL[k]) in the nPCL matches the remaining feature points in the PCL other than the corresponding feature point (PCL[j]) in the PCL with the minimum distance therebetween to determine whether any feature point (nPCL[k]) in the nPCL is the feature point that is not searched in the previous object search cycle. In other words, it is determined whether a positional relationship between any feature point (nPCL[k]) in the nPCL and the remaining feature points other than the corresponding feature point in the PCL satisfies a positional relationship between the corresponding feature point and the remaining feature points in the PCL.

In a or operation step S330, when the positional relationship between any feature point (nPCL[k]) in the nPCL and the remaining feature points other than the corresponding feature point (PCL[j]) in the PCL satisfies the positional relationship between the corresponding feature point (PCL[j]) and the remaining feature points in the PCL, it is determined that any feature point (nPCL[k]) in the nPCL is the same as the corresponding feature point (PCL[j]) in the PCL. Therefore, the method proceeds to a step or operation S320, and the controller 50 determines whether another feature point in the nPCL is the same as the feature point in the PCL by repeating steps or operations S320 and S330.

In the step or operation S330, when the positional relationship between any feature point (nPCL[k]) in the nPCL and the remaining feature points other than the corresponding feature point (PCL[j]) in the PCL does not satisfy the positional relationship between the corresponding feature point (PCL[j]) and the remaining feature points in the PCL, it is determined that any feature point (nPCL[k]) in the nPCL is not the same as the feature points in the PCL. Therefore, the method proceeds to a step or operation S340 at which the controller 50 adds the corresponding feature point (nPCL[k]) in the nPCL to the PCL. Thereafter, the controller 50 updates the PCL in a step or operation S350.

Referring back to FIG. 2, when the PCL is updated by removing the feature points that satisfy the removal condition from the PCL and adding newly searched feature points to the PCL, the controller 50 performs the SLAM with the updated PCL in a step or operation S140. In other words, by using the feature points in the updated PCL, the location is detected and the map is created. Since the SLAM using the feature points is well known to those having ordinary skill in the art, a detailed description thereof has been omitted.

In a step or operation S150, the controller 50 determines whether SLAM is terminated. When the processor 50 determines in the step or operation S150 that SLAM is not terminated, the method returns to the step or operation S110 in which the controller 50 determines whether the object search cycle has arrived. In contrast, when the controller 50 determines in the step or operation S150 that SLAM is terminated, the method is terminated.

Hereinafter, with reference to FIGS. 5-9, a method for SLAM, according to an embodiment of the present disclosure, is described in more detail.

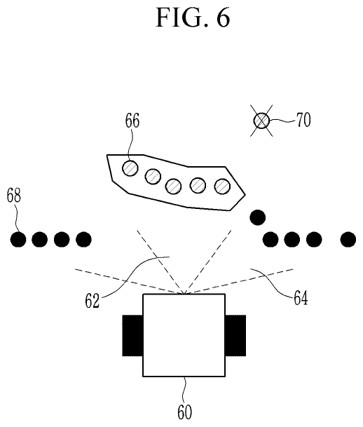

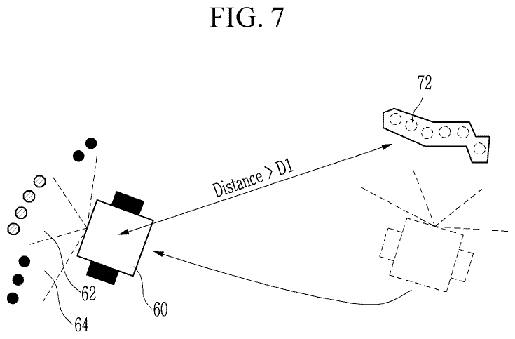

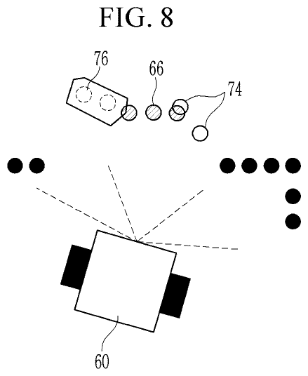

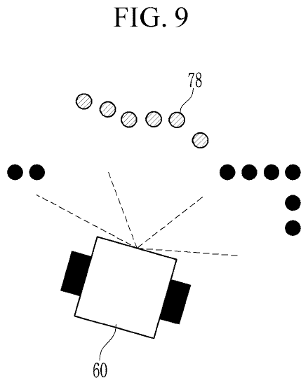

FIG. 5 illustrates feature points detected by a Lidar and a camera, according to an embodiment. FIG. 6 illustrates removal of noise from the feature points detected as illustrated in FIG. 5, according to an embodiment. FIG. 7 illustrates deleting stored feature points, according to an embodiment. FIG. 8 illustrates maintaining stored feature points and adding new feature points, according to an embodiment. FIG. 9 illustrates a point cloud (PCL) in which the stored feature points are maintained and the new feature points are added as illustrated in FIG. 8, according to an embodiment.

In an embodiment, when the object search cycle arrives, the controller 50 searches for feature points 66, 68, and 70 using the Lidar 10 and the camera 40. As illustrated in FIG. 5, the field of view 64 of the Lidar 10 is wider than the field of view 62 of the camera 40. As a result, some feature points 68 are detected only by the Lidar 10, and the other feature points 66 are detected by the Lidar 10 and the camera 40.

After updating the PCL by searching for the object in the previous object search cycle, the vehicle 60 may move along the path until the current object search cycle. Accordingly, when the current object search cycle arrives, the controller 50 deletes, from the PCL, a feature point 72 that satisfies the removal condition among the feature points 66, 68, and 72 stored in the PCL. For example, as illustrated in FIG. 7, when the distance between the vehicle 60 and the feature point 72 is greater than the first set distance, the feature point 72 is deleted from the PCL.

When the feature point 72 that satisfies the removal condition is deleted from the PCL, the controller 50 searches for the new feature points 66, 68, and 70. For example, as illustrated in FIG. 5, the feature point 68 is searched by the Lidar 10, the feature points 66 and 70 are searched by the camera 40, and the controller 50 sets a set of newly searched feature points 66, 68, and 70 as the nPCL.

The controller 50 removes the noise 70 from the searched feature points 66, 68, and 70. For example, as illustrated in FIG. 6, the noise 70 determined through the data clustering, etc., is removed from the nPCL.

Thereafter, the controller 50 determines whether the newly searched feature points are the same as the existing feature points. For example, as illustrated in FIG. 8, a new feature point 74 is compared with the existing feature point 66. The controller 50 determines whether there is a new feature point 74 whose minimum value of the distances between the new feature point 74 and the existing feature points is less than the second set distance D2. Referring to FIG. 8, in an example, the minimum value of the distance between the feature point 74 on the left and the existing feature point 66 is less than the second set distance D2, but the minimum value of the distance between the feature point 74 on the right and the existing feature point 66 is greater than the second set distance D2. Accordingly, referring to FIG. 9, the new feature point 74 on the right is added to the PCL as a new feature point 78.

Thereafter, the controller 50 determines whether the positional relationship between the remaining existing feature points other than the existing feature point with the minimum distance from the new feature point and the new feature point matches the positional relationship between the existing feature point with the minimum distance from the new feature point and the remaining existing feature points other than the corresponding feature point. For example, referring to FIG. 8, the positional relationship between the rightmost feature point 66 among the existing feature points 66 searched by the camera 40 and the existing feature point 66 other than the rightmost feature point 66 corresponds to the positional relationship between the new feature point 74 on the left and the existing feature point 66 other than the rightmost feature point 66. Accordingly, the new feature point 74 on the left is determined to be the existing feature point 66 and thus is not added to the PCL.

Referring still to FIG. 8, a feature point 76′ is an existing feature point that is not newly searched. The feature point 76 does not satisfy the removal condition, Therefore, the feature point 76 is not deleted and is maintained in the PCL.

As a result, the PCL is updated as illustrated in FIG. 9.

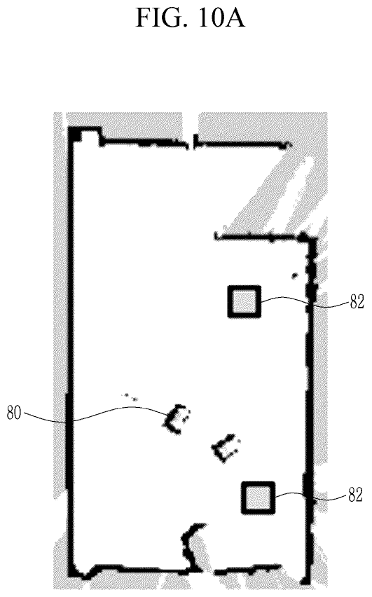

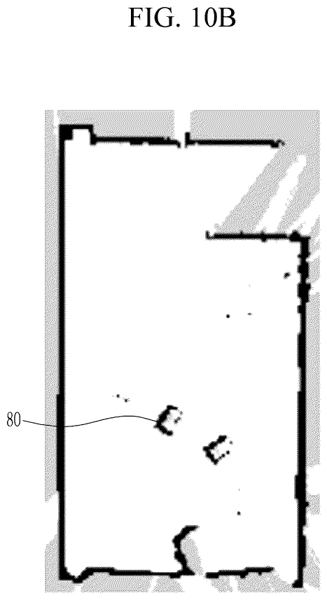

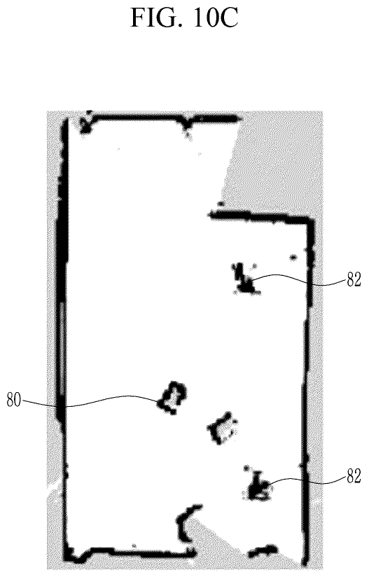

FIG. 10A illustrates an example of a map of an arbitrary location, according to an embodiment. FIG. 10B illustrates an example of a map created with a conventional 2D SLAM for the location illustrated in FIG. 10A. FIG. 10C illustrates an example of a map created using SLAM according to an embodiment of the present disclosure for the location of FIG. 10A.

As illustrated in FIG. 10A, there are two first objects 80 and two second objects 82 in the location. As illustrated in FIG. 10B, when the map is created using the conventional 2D SLAM, the first object 80 is searched but the second object 82 may not be detected due to the difference between viewing angles of the Lidar 10 and the camera 40. In this way, when the vehicle 60 drives using the map in which the second object 82 is missing, there is a possibility that the vehicle 60 will collide with the second object 82. In contrast, as illustrated in FIG. 10C, according to an embodiment of the present disclosure, even if the feature points are out of the field of view of the camera 40, which has a relatively narrow field of view, the feature points are maintained if the feature points do not satisfy the removal condition. As a result, the missing of the feature points does not occur due to the difference between the viewing angles of the two types of detectors. Accordingly, as illustrated in FIG. 10C, the two first objects 80 and the two second objects 82 are searched in the map created with the SLAM according to the embodiment of the present disclosure.

While the inventive concepts of the present disclosure are described above in connection with what is presently considered to be practical embodiments, it should to be understood that the present disclosure is not limited to the described embodiments. On the contrary, the present disclosure is intended to cover various modifications and equivalent arrangements included within the spirit and scope of the appended claims.

What is claimed is:

1. A system for simultaneous localization and mapping (SLAM), the system comprising:
a light detection and ranging (Lidar) sensor configured to detect a feature point in front of a vehicle;
a camera configured to acquire a front image of the vehicle; and
a controller configured to
receive data on the feature point in front of the vehicle from the Lidar sensor,
receive the front image of the vehicle from the camera,
search for the feature point from the front image,
set the feature point received from the Lidar sensor and the feature point searched from the front image as a point cloud (PCL),
perform SLAM based on the feature point in the PCL,
remove a feature point satisfying a removal condition from the PCL in response to an arrival of an object search cycle, wherein the feature point that satisfies the removal condition is a feature point whose distance to the vehicle is greater than a first set distance, and
add a newly searched feature point after a previous object search cycle to the PCL.

2. The system of claim 1, wherein the controller is further configured to maintain, in the PCL, a feature point that does not satisfy the removal condition.

3. The system of claim 1, wherein the controller is configured to first remove the feature point that satisfies the removal condition from the PCL and then add the newly searched feature point to the PCL.

4. The system of claim 1, wherein the controller is further configured to:
set the newly searched feature point after the previous object search cycle as a new point cloud (nPCL);
determine whether the feature point in the nPCL is the same as the feature point in the PCL; and
add the corresponding feature point in the nPCL to the PCL in response to determining that the feature point in the nPCL is not the same as the feature point in the PCL.

5. The system of claim 4, wherein the controller is configured to determine that the feature point in the nPCL is not the same as the feature point in the PCL in response to determining that a minimum value of a distance between the feature point in the nPCL and the feature point in the PCL is greater than or equal to a second set distance.

6. The system of claim 5, wherein the controller is configured to:
determine that a positional relationship between the feature point in the nPCL and the feature point other than the corresponding feature point in the PCL matches a positional relationship between the corresponding feature point in the PCL and the feature point other than the corresponding feature point in the PCL in response to determining that the minimum value of the distance between the feature point in the nPCL and the feature point in the PCL is less than the second set distance; and
determine that the feature point in the nPCL is not the same as the feature point in the PCL in response to determining that the positional relationship between the feature point in the nPCL and the feature point other than the corresponding feature point in the PCL does not match the position relationship between the feature point in the PCL and the feature point other than the corresponding feature point in the PCL.

7. The system of claim 6, wherein the controller is further configured to, in response to determining that the positional relationship between the feature point in the nPCL and the feature point other than the corresponding feature point in the PCL matches the positional relationship between the corresponding feature point in the PCL and the feature point other than the corresponding feature point in the PCL, determine that the corresponding feature point in the nPCL is the same as the corresponding feature point in the PCL.

8. The system of claim 4, wherein the controller is further configured to remove noise in the nPCL through data clustering.

9. A method for simultaneous localization and mapping (SLAM), the method comprising:
receiving, by a controller of a vehicle, data on a feature point in front of the vehicle from a light detection and ranging (Lidar) sensor in response to SLAM being triggered;
receiving, by the controller, a front image of the vehicle from a camera;
searching, by the controller, for a feature point from the front image;
setting, by the controller, the feature point transmitted from the Lidar sensor and the feature point searched from the front image as a point cloud (PCL);
removing, by the controller, a feature point that satisfies a removal condition from the PCL in response to an arrival of an object search cycle; and
adding, by the controller, a newly searched feature point after a previous object search cycle to the PCL.

10. The method of claim 9, wherein the feature point that satisfies the removal condition is a feature point where a distance to the vehicle is greater than a first set distance.

11. The method of claim 9, further comprising maintaining, by the controller, the feature point that does not satisfy the removal condition in the PCL.

12. The method of claim 9, wherein adding the newly searched feature point after the previous object search cycle to the PCL includes:
setting the newly searched feature point after the previous object search cycle as a new point cloud (nPCL);
determining whether the feature point in the nPCL is the same as the feature point in the PCL; and
adding the corresponding feature point in the nPCL to the PCL in response to determining that the feature point in the nPCL is not the same as the feature point in the PCL.

13. The method of claim 12, wherein determining whether the feature point in the nPCL is the same as the feature point in the PCL includes comparing a minimum value of a distance between the feature point in the nPCL and the feature point in the PCL with a second set distance.

14. The method of claim 13, wherein determining whether the feature point in the nPCL is the same as the feature point in the PCL includes determining that the feature point in the nPCL is not the same as the feature point in the PCL in response to determining that the minimum value of the distance between the feature point in the nPCL and the feature point in the PCL is greater than or equal to the second set distance.

15. The method of claim 13, wherein determining whether the feature point in the nPCL is the same as the feature point in the PCL includes determining whether a positional relationship between the feature point in the nPCL and the feature point other than the corresponding feature point in the PCL matches a positional relationship between the corresponding feature point in the PCL and the feature point other than the corresponding feature point in the PCL in response to determining that the minimum value of the distance between the feature point in the nPCL and the feature point in the PCL is less than the second set distance.

16. The method of claim 15, wherein determining whether the feature point in the nPCL is the same as the feature point in the PCL further includes determining that the feature point in the nPCL is not the same as the feature point in the PCL in response to determining that the positional relationship between the feature point in the nPCL and the feature point other than the corresponding feature point in the PCL does not match the positional relationship between the corresponding feature point in the PCL and the feature point other than the corresponding feature point in the PCL.

17. The method of claim 15, wherein determining whether the feature point in the nPCL is the same as the feature point in the PCL further includes determining that the corresponding feature point in the nPCL is the same as the corresponding feature point in the PCL in response to determining that the positional relationship between the feature point in the nPCL and the feature point other than the corresponding feature point in the PCL matches the positional relationship between the feature point in the PCL and the feature point other than the corresponding feature point in the PCL.

18. The method of claim 12, wherein adding the newly searched feature point to the PCL after the previous object search cycle further includes removing noise in the nPCL through data clustering.
